(19) United States
(12) Patent Application Publication
(10) Pub. No.: US 2022/0101084 A1
(43) Pub. Date: Mar. 31, 2022

(54) PIPELINING FOR ANALOG-MEMORY-BASED NEURAL NETWORKS WITH ALL-LOCAL STORAGE

(71) Applicant: INTERNATIONAL BUSINESS MACHINES CORPORATION, Armonk, NY (US)

(72) Inventor: Geoffrey Burr, San Jose, CA (US)

(21) Appl. No.: 17/036,246

(22) Filed: Sep. 29, 2020

(51) Int. Cl. G06N 3/04; G06N 3/08

(52) U.S. Cl. CPC G06N 3/04; G06N 3/084

(57) ABSTRACT

Pipelining for analog-memory-based neural networks with all-local storage is provided. In various embodiments, an array of inputs is received by a first synaptic array in a hidden layer from a prior layer during a feed forward operation. The array of inputs is stored by the first synaptic array during the feed forward operation. The array of inputs is received by a second synaptic array in the hidden layer during the feed forward operation. The second synaptic array computes outputs from array of inputs based on weights of the second synaptic array during the feed forward operation. The stored array of inputs is provided from the first synaptic array to the second synaptic array during a back propagation operation. Correction values are received by the second synaptic array during the back propagation operation. Based on the correction values and the stored array of inputs, the weights of the second synaptic array are updated.

### BACKGROUND

Embodiments of the present disclosure relate to neural network circuits, and more specifically, to pipelining for analog-memory-based neural networks with all-local storage.

### BRIEF SUMMARY

According to embodiments of the present disclosure, artificial neural networks are provided. In various embodiments, an artificial neural network comprises a plurality of synaptic arrays. Each of the plurality of synaptic arrays comprises a plurality of ordered input wires, a plurality of ordered output wires, and a plurality of synapses. Each of the synapses is operatively coupled to one of the plurality of input wires and to one of the plurality of output wires. Each of the plurality of synapses comprises a resistive element configured to store a weight. The plurality of synaptic arrays are configured in a plurality of layers, comprising at least one input layer, one hidden layer, and one output layer. A first of the at least one of the synaptic arrays in the at least one hidden layer is configured to receive and store an array of inputs from a prior layer during a feed forward operation. A second of the at least one of the synaptic arrays in the at least one hidden layer is configured to receive the array of inputs from the prior layer, and compute outputs from the at least one hidden layer based on the weights of the second synaptic array during the feed forward operation. The first of the at least one of the synaptic arrays is configured to provide the stored array of inputs to the second of the at least one of the synaptic arrays during a back propagation operation. The second of the at least one of the synaptic arrays is configured to receive correction values during the back propagation operation, and based on the correction values and the stored array of inputs, update its weights.

According to embodiments of the present disclosure, devices comprising a first and a second synaptic array are provided. Each of the first and second synaptic arrays comprise a plurality of ordered input wires, a plurality of ordered output wires, and a plurality of synapses. Each of the plurality of synapses is operatively coupled to one of the plurality of input wires and to one of the plurality of output wires. Each of the plurality of synapses comprises a resistive element configured to store a weight. The first synaptic array is configured to receive and store an array of inputs from a prior layer of artificial neural network during feed forward operation. The second synaptic array is configured to receive the array of inputs from the prior layer, and compute outputs based on the weights of the second synaptic array during the feed forward operation. The first synaptic array is configured to provide the stored array of inputs to the second synaptic array during a back propagation operation. The second synaptic array is configured to receive correction values during the back propagation operation, and based on the correction values and the stored array of inputs, update its weights.

According to embodiments of the present disclosure, methods of and computer program products for operating neural network circuits are provided. An array of inputs is received by a first synaptic array in a hidden layer from a prior layer during a feed forward operation. The array of inputs is stored by the first synaptic array during the feed forward operation. The array of inputs is received by a second synaptic array in the hidden layer during the feed forward operation. The second synaptic array computes outputs from array of inputs based on weights of the second synaptic array during the feed forward operation. The stored array of inputs is provided from the first synaptic array to the second synaptic array during a back propagation operation. Correction values are received by the second synaptic array during the back propagation operation. Based on the correction values and the stored array of inputs, the weights of the second synaptic array are updated.

### BRIEF DESCRIPTION OF THE SEVERAL VIEWS OF THE DRAWINGS

FIG. 1 illustrates an exemplary nonvolatile memory-based crossbar array, or crossbar memory according to embodiments of the present disclosure.

FIG. 2 illustrates exemplary synapses within a neural network according to embodiments of the present disclosure.

FIG. 3 illustrates an exemplary array of neural cores according to embodiments of the present disclosure.

FIG. 4 illustrates an exemplary neural network according to embodiments of the present disclosure.

FIGS. 5A-E illustrate steps of forward propagation according to embodiments of the present disclosure.

FIGS. 6A-E illustrate steps of back propagation according to embodiments of the present disclosure.

FIGS. 7A-E illustrate simultaneous steps for both forward and back propagation according to embodiments of the present disclosure.

FIG. 8 illustrates a method of operating a neural network according to embodiments of the present disclosure.

FIG. 9 depicts a computing node according to an embodiment of the present disclosure.

### DETAILED DESCRIPTION

Artificial neural networks (ANNs) are distributed computing systems, which consist of a number of neurons interconnected through connection points called synapses. Each synapse encodes the strength of the connection between the output of one neuron and the input of another. The output of each neuron is determined by the aggregate input received from other neurons that are connected to it. Thus, the output of a given neuron is based on the outputs of connected neurons from the preceding layer and the strength of the connections as determined by the synaptic weights. An ANN is trained to solve a specific problem (e.g., pattern recognition) by adjusting the weights of the synapses such that a particular class of inputs produce a desired output.

ANNs may be implemented on various kinds of hardware, including crossbar arrays, also known as crosspoint arrays or crosswire arrays. A basic crossbar array configuration includes a set of conductive row wires and a set of conductive column wires formed to intersect the set of conductive row wires. The intersections between the two sets of wires are separated by crosspoint devices. Crosspoint devices function as the ANN's weighted connections between neurons.

In various embodiments, a nonvolatile memory-based crossbar array, or crossbar memory, is provided. A plurality of junctions are formed by row lines intersecting column lines. A resistive memory element, such as a non-volatile memory, is in series with a selector at each of the junctions coupling between one of the row lines and one of the column lines. The selector may be a volatile switch or a transistor, various types of which are known in the art. It will be appreciated that a variety of resistive memory elements are suitable for use as described herein, including memristors, phase-change memories, conductive-bridging RAMs, and spin-transfer torque RAMs.

A fixed number of synapses may be provided on a core, and then multiple cores connected to provide a complete neural network. In such embodiments, interconnectivity between cores is provided to convey outputs of the neurons on one core to another core, for example, via a packet-switched or circuit-switched network. In a packet-switched network, greater flexibility of interconnection may be achieved, at a power and speed cost due to the need to transmit, read, and act on address bits. In a circuit-switched network, no address bits are required, and so flexibility and re-configurability must be achieved through other means.

In various exemplary networks, a plurality of cores is arranged in an array on a chip. In such embodiments, relative positions of cores may be referred to by the cardinal directions (north, south, east, west). Data carried by neural signals may be encoded in the pulse-duration carried by each wire, using digital voltage levels suitable for buffering or other forms of digital signal restoration.

One approach to routing is to provide Analog-to-Digital converters at the output edge of each core, paired with a digital network-on-chip for rapidly routing packets to any other core, and with Digital-to-Analog converters at the input edge of each core.

Training of Deep Neural Networks (DNNs) involves three different steps: 1) forward-inference of a training example through the entire network to the output; 2) back-propagation of the deltas or corrections based on difference between the guessed output and the known ground-truth output for that training example; and 3) weight-update of each weight in the network by combining the original forward excitation (x) associated with the neuron just upstream from the synaptic weight together with the back-propagated delta associated with the neuron just downstream from the synaptic weight.

Pipelining of this training process is complicated by the fact that these two pieces of data needed for weight update are produced at widely different times. The incoming excitation values (x vector) is produced during the forward pass, while the incoming delta values (delta vector) is not produced until the entire forward pass has completed and the reverse pass has returned to the same neural network layer. For a layer that sits early in the neural network, this implies that the x vector data that will be needed later must be stored in the meantime—and the number of such vectors that must be stored and later retrieved could be very large.

In particular, to do a weight update at a layer q, the excitations corresponding to input m (e.g., an image) produced at some time step t are required. In addition, the deltas for layer q are required, which are not available until timestep t+2l, where 1 is the number of layers between q and the output of the network.

Meanwhile, forward-inference-only pipelining approaches that do not require long-term storage of the x vectors can efficiently pass these vectors from one array-core implementing a neural network layer to the next array-core with extremely local routing, so that all layers can be working on data simultaneously. For instance, the array-core(s) associated with the N^{th} DNN layer can be working on the N^{th} data-example, while the array-core(s) for the N−1^{st} layer work on the N−1^{st} data example. This approach, where multiple chunks of data proceed by stages through a hardware system is known as pipelining. It is particularly efficient since each component is continuously kept busy, even though neighboring components may be working on different parts of the same problem or data-example, or even on completely different data-examples.

Approaches for pipelined training that digitize all x and delta vectors and store them elsewhere on the chip have been described. Such approaches require digitization, long-distance routing of digital data, and significant amounts of memory, and any of these elements can become the bottleneck as the number of neural network layers becomes large.

Accordingly, there is a need for a technique to allow pipelining of deep neural network training that offers the same scalability to large networks by eliminating all the long-range data traffic.

The present disclosure provides a 5-step sequence, with two or more logical array-cores assigned to each neural network layer. These array-cores can either be uniquely provisioned or can be otherwise identical. One array-core is responsible for extremely-local short-term storage of x vectors produced during the forward pass; the other array-core operates in the usual crossbar array or RPU (Resistive Processing Unit) modes of forward propagation (producing the next x vectors), reverse propagation (producing delta vectors) and weight update.

In some embodiments, the short-term storage can be distributed over a plurality of array-cores, while the RPU/crossbar functionality can also be distributed over a plurality of array-cores. At the other end of the distribution spectrum, the two roles of short-term storage and crossbar functionality could be implemented on one physical array-core or tile.

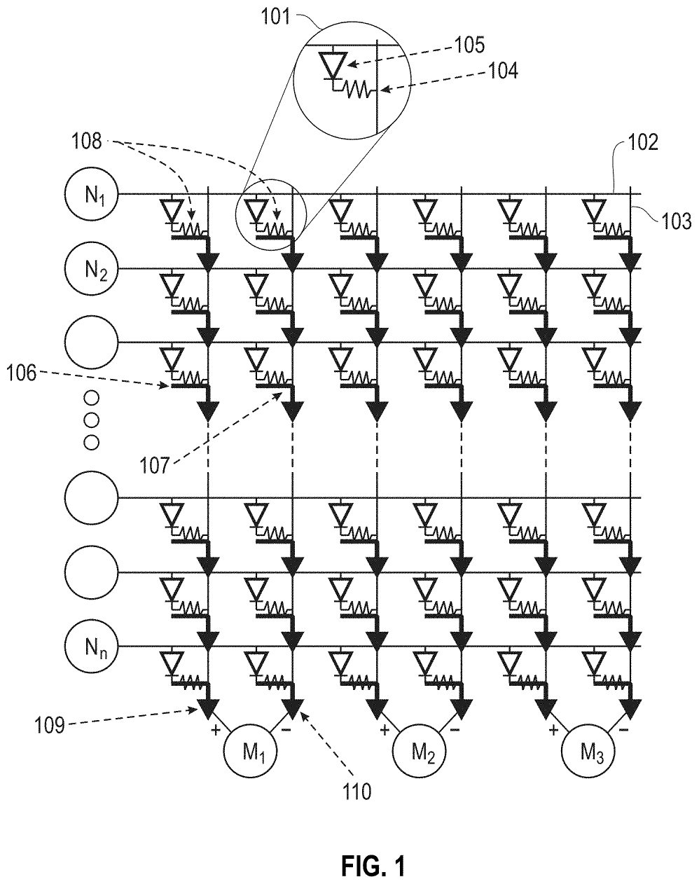

Referring to FIG. 1, an exemplary nonvolatile memory-based crossbar array, or crossbar memory, is illustrated. A plurality of junctions 101 are formed by row lines 102 intersecting column lines 103. A resistive memory element 104, such as a non-volatile memory, is in series with a selector 105 at each of the junctions 101 coupling between one of the row lines 102 and one of the column lines 103. The selector may be a volatile switch or a transistor, various types of which are known in the art.

It will be appreciated that a variety of resistive memory elements are suitable for use as described herein, including memristors, phase-change memories, conductive-bridging RAMs, spin-transfer torque RAMs.

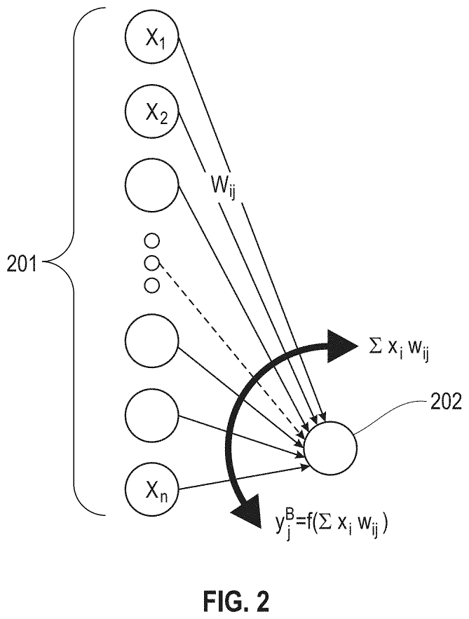

Referring to FIG. 2, exemplary synapses within a neural network are illustrated. A plurality of inputs x₁ . . . xₙ, from nodes 201 are multiplied by corresponding weights wᵢⱼ. The sum of the weights, Σxᵢwᵢⱼ is provided to a function f(·) at node 202 to arrive at a value yⱼ^{B}=f(Σxᵢwᵢⱼ). It will be appreciated that a neural network would include a plurality of such connections between layers, and that this is merely exemplary.

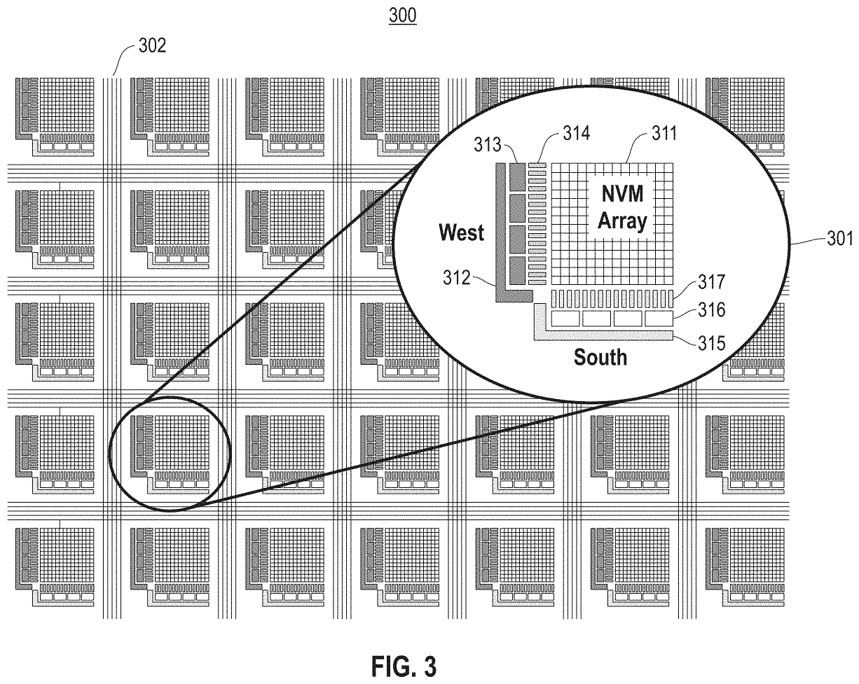

Referring now to FIG. 3, an exemplary array of neural cores is illustrated according to embodiments of the present disclosure. Array 300 includes a plurality of cores 301. The cores in array 300 are interconnected by lines 302, as described further below. In this example, the array is two-dimensional. However, it will be appreciated that the present disclosure may be applied to a one-dimensional or three-dimensional array of cores. Core 301 includes non-volatile memory array 311, which implements synapses as described above. Core 301 includes a west side and a south side, each of which may serve as input while the other serves as output. It will be appreciated that the west/south nomenclature is adopted merely for ease of reference to relative positioning, and is not meant to limit the direction of inputs and outputs.

In various exemplary embodiments, the west side includes support circuitry 312, which is dedicated to the entire side of core 301, shared circuitry 313, which is dedicated to a subset of rows, and per-row circuitry 314, which is dedicated to individual rows. In various embodiments the south side likewise includes support circuitry 315, which is dedicated to the entire side of core 301, shared circuitry 316, which is dedicated to a subset of columns, and per-column circuitry 317, which is dedicated to individual columns.

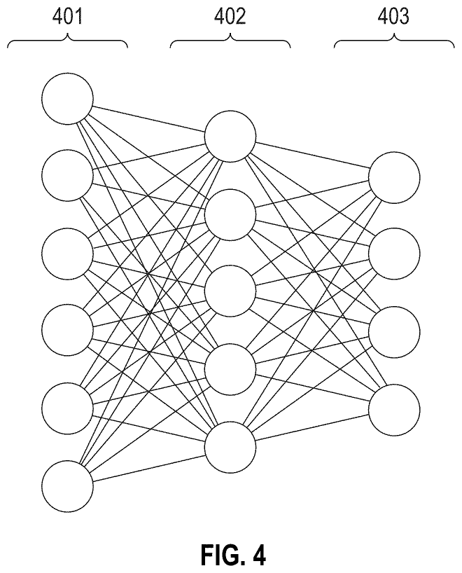

Referring to FIG. 4, an exemplary neural network is illustrated. In this example, a plurality of input nodes 401 are interconnected with a plurality of intermediate nodes 402. In turn, intermediate nodes 402 are interconnected with output nodes 403. It will be appreciated that this simple feed-forward network is presented solely for illustrative purposes, and the present disclosure is applicable irrespective of the particular neural network arrangement.

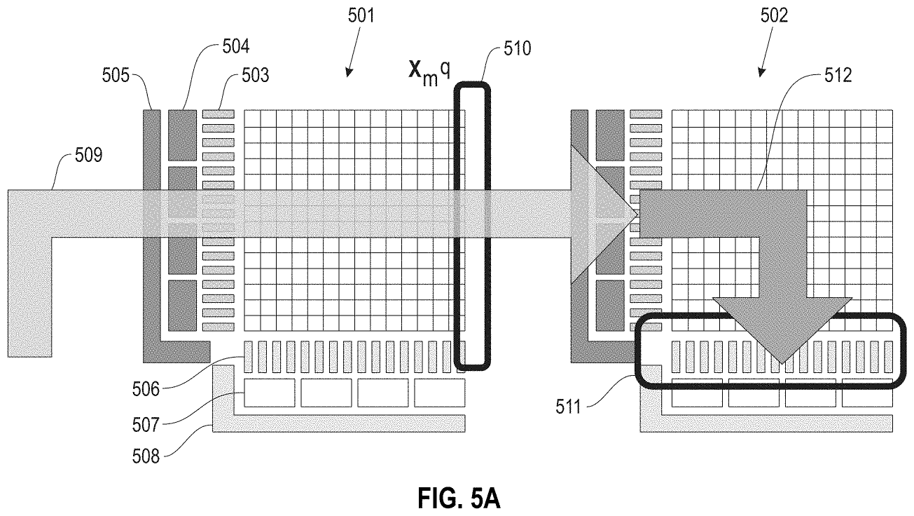

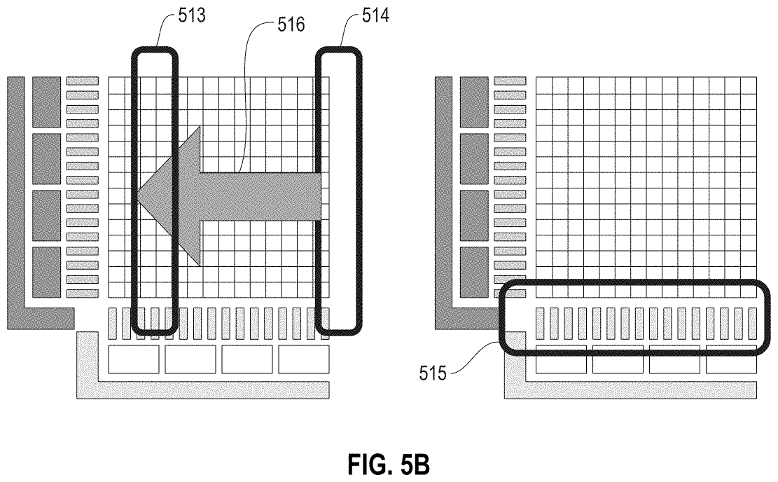

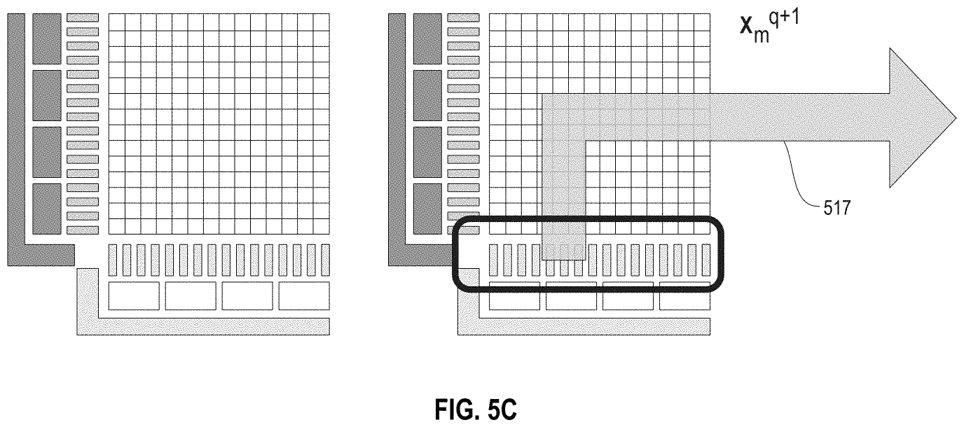

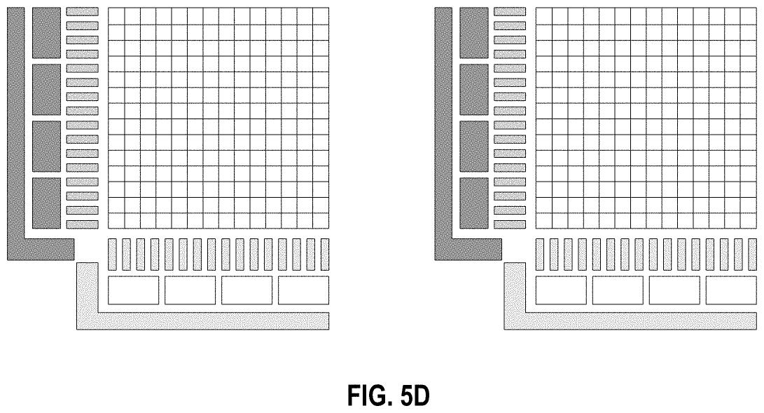

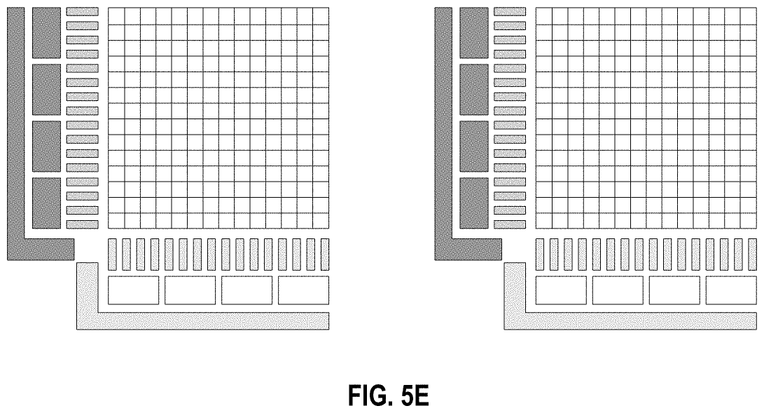

Referring to FIGS. 5A-E, steps of forward propagation are illustrated according to embodiments of the presented disclosure. Each of FIGS. 5A-E illustrate the operation of a pair of arrays at a time slice.

In the first step, shown in FIG. 5A, the parallel data vector containing the x vectors for layer q of image m is propagated across the array-cores 501, 502 to arrive at the RPU array-core 502 responsible for layer q computation. The x vectors are also preserved in the East-side periphery of array-core 501 responsible for layer q storage. The multiply-accumulate operations take place, setting up the next x vector.

Boxes 503 . . . 505 at the West edge of each crossbar indicate at-row and shared peripheral circuitry associated with the rows of the crossbar array, for driving forward excitations, for analog measurement of integrated current during reverse propagation, and for applying the retrieved forward excitations during the weight-update stage.

Similarly, boxes 506 . . . 508 at the South edge indicate at-column and shared peripheral circuitry associated with the columns, for analog measurement of integrated current during forward excitation, for driving reverse excitations onto columns, and for applying those reverse excitations during the weight-update stage.

Arrow 509 indicates data-vector propagation on the parallel routing wires that go over each array, while boxes 510, 511 mark capacitors that are getting updated (e.g., filled or drained) during this first step. Arrow 512 indicates current integration on the array (multiply-accumulate). During this step, excitations are being captured at the east edge of the left-hand array-core as it goes past, AND these excitations are driving the rows in the right-hand array-core. This leads to current integration along the columns that implement a massively-parallel multiply-accumulate operation. At the end of this step, integrated charge representing the analog results of these operations are sitting in capacitors at the South edge of the right-hand array-core, as indicated by the box 511.

In the second step, shown in FIG. 5B, the x vector data (xₘ^{q}) held in the East-side periphery of the storage array-core is written column-wise into the data column 513 associated with image m. In some embodiments, this would be done using an NVM of high endurance or the 3T1C (three-transistor one-capacitor) or similar synaptic circuit element which offers near-infinite endurance and a storage lifetime of several milliseconds.

Boxes 514, 515 mark capacitors that are holding a value from previous timestep—in this case, at the East edge of the left-hand array-core, and at the South edge of the right-hand array-core. Arrow 516 indicates parallel row-wise write into 3T1C (three transistor+1 capacitor) devices, or any other device capable of rapid and precise writing of analog state with very high endurance.

In the third step, shown in FIG. 5C, the next x vector data at the South-side of the computation array-core is placed onto the routing network and sent to the q+1 layer. This process can either inherently include the squashing function operation, or the squashing function can be applied at a point along the routing path before the ultimate destination.

In the third and fourth steps, shown in FIGS. 5D-E, no action is needed. These time slices will be used for other training tasks before the next image can be processed.

While this list has detailed the operations on the array-cores associated with the q^{th} layer, this implies that the q+1 layer executes exactly these same operations, shifted in phase by 2 steps. This implies that arrow 517 in the third step (which correspond to data leaving layer q) is equivalent to arrow 509 seen in the first step for the q+1 layer (corresponding to data arriving at layer q+1). By extension, the q+2 layer executes again these same operations, shifted in phase by 4 steps from the original layer q. In other words, during forward propagation, all array-cores are busy on 3 out of 5 phases.

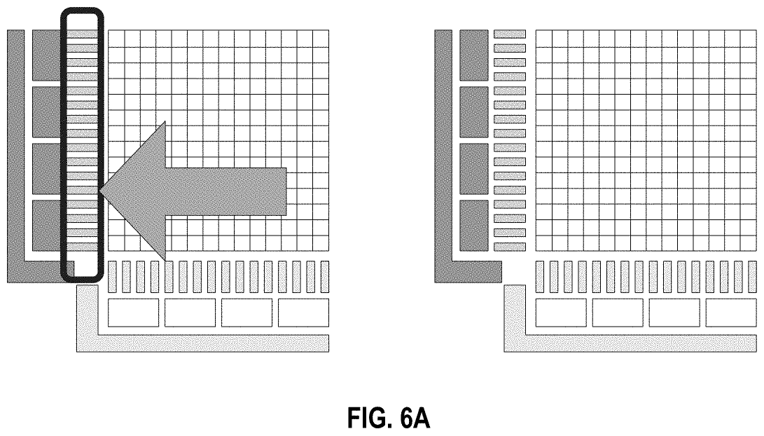

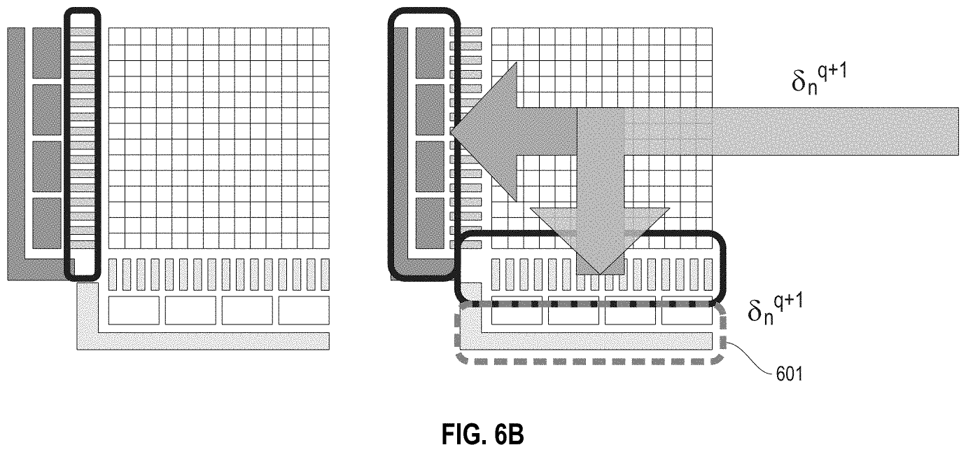

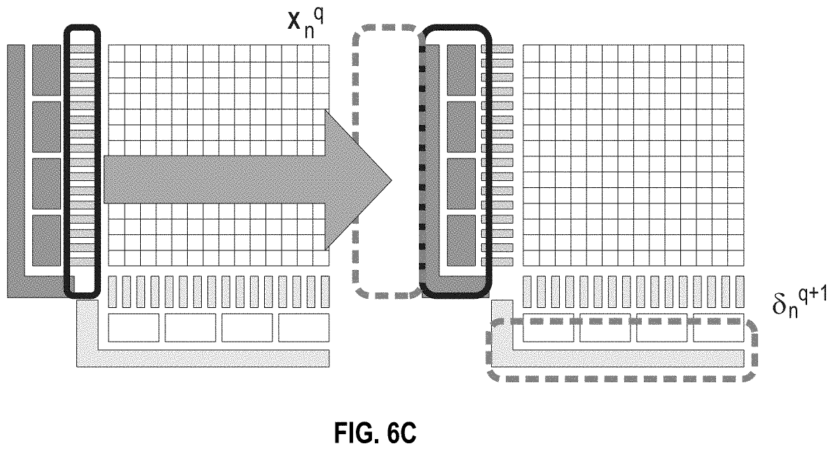

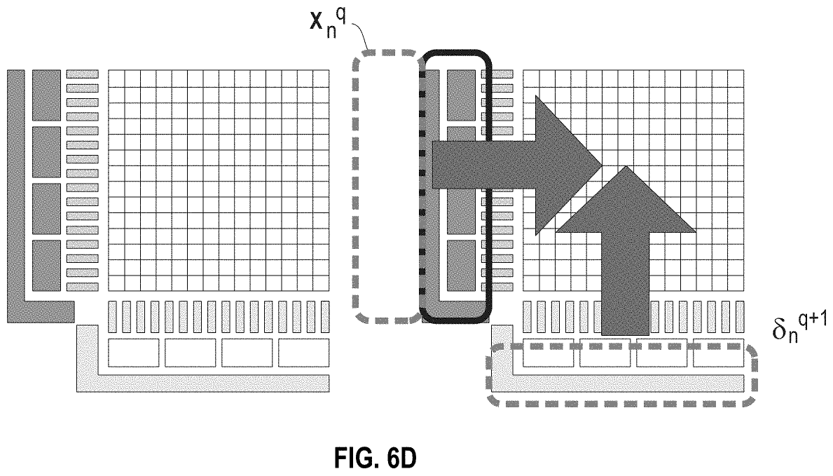

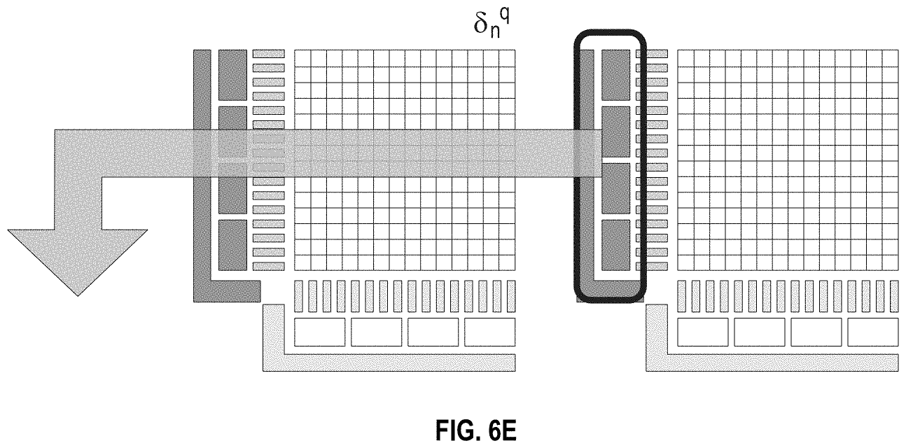

Referring now to FIGS. 6A-E, steps of back propagation are illustrated according to embodiments of the presented disclosure. Each of FIGS. 6A-E illustrate the operation of a pair of arrays at a time slice.

During the first step, shown in FIG. 6A, the previously stored copy of the x vector for image n is retrieved, so that it is available at the west-side periphery of the layer q storage array-core. Note that this was likely stored at some time in the past, when image n was processed for forward propagation.

During the second step, shown in FIG. 6B, the parallel delta vector for layer q of image n is propagated through the routing network to arrive at the south side of the same RPU array-core, leading to transpose multiply-accumulate operations (columns driven, integration along rows), resulting in stored charge representing the next delta vector in the West-side capacitors of the layer q computation array-core. A copy of the arriving delta vector is preserved in the south-side peripheral circuitry (indicated by box 601).

During the third step, shown in FIG. 6C, the previously retrieved x vector is transmitted from the storage array-core to the computation array-core, so that it is now available to the west-side periphery of the layer q computation array-core.

During the fourth step, shown in FIG. 6D, the x vector information at the west-side periphery and the delta vector information at the south-side periphery are combined to perform crossbar-compatible weight update (RPU-array neural network weight-update).

During the fifth step, shown in FIG. 6E, any derivative information available at the west-side periphery is applied to the next delta vector that was produced in the second step. This information is then placed onto the overhead routing network, passing over the left-hand array-core to arrive at the next earlier layer, q−1.

The phase discrepancy between each column of array-cores is self-consistent with that observed during the forward propagation step. Thus, each layer of the network is doing useful work during each timestep of operation, allowing full pipelining of training.

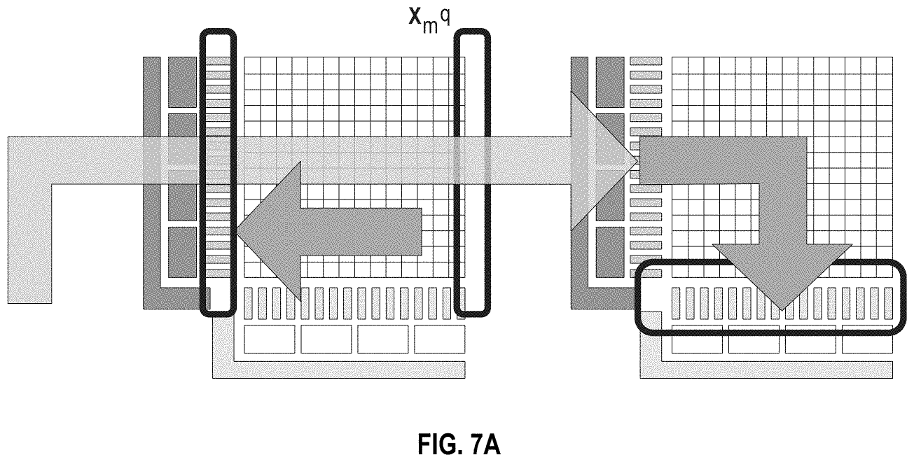

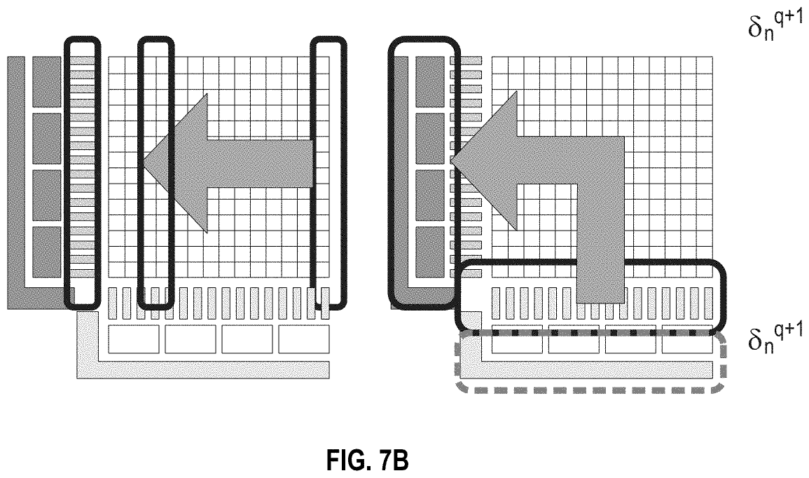

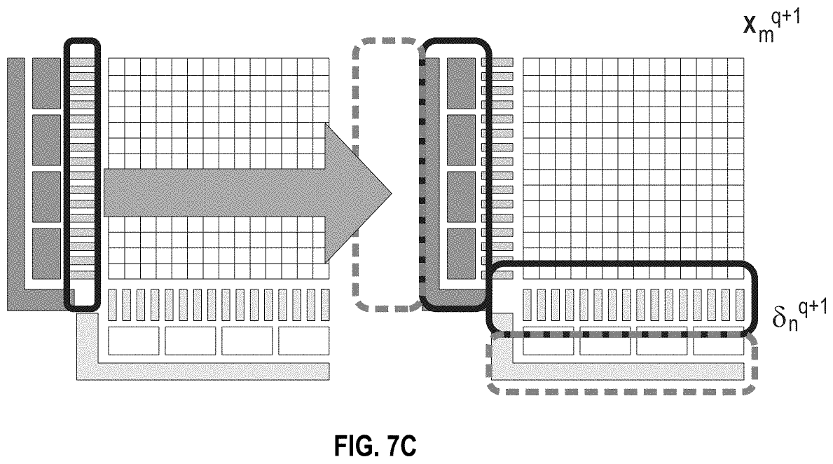

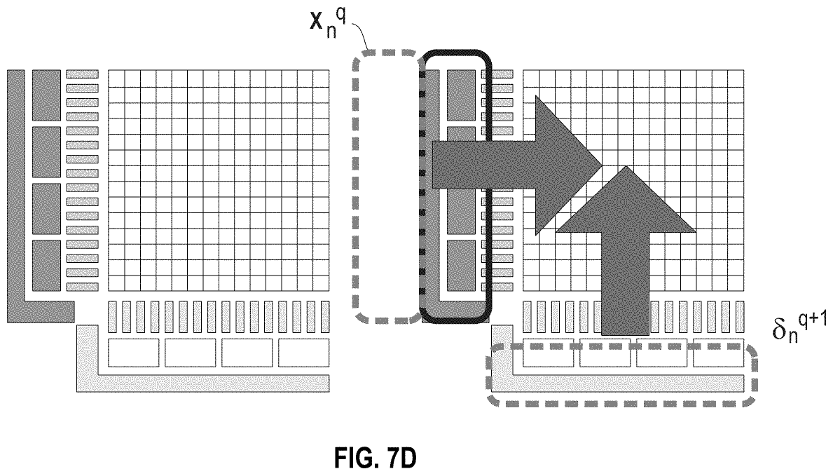

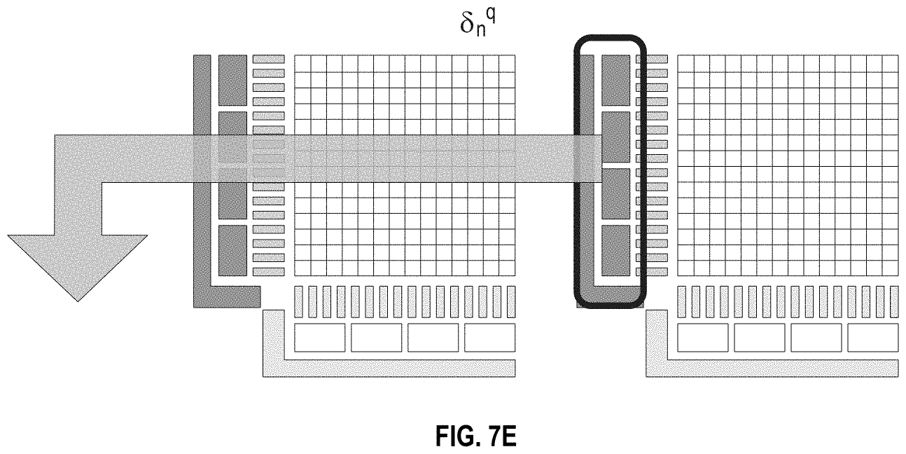

Referring now to FIGS. 7A-E, simultaneous steps for both forward and back propagation according to embodiments of the present disclosure are illustrated. As shown in these composite images, the steps provided in FIGS. 5A-E and FIGS. 6A-E are entirely self-consistent and can be performed simultaneously in five time steps. This implies that all storage is local, and this scheme can scale to arbitrarily large neural networks, so long as the routing paths can be performed without contention. The maximum depth of the network that would be supported is limited by the number of columns available for storage of x vectors, since one column of intermediate storage is used on each set of five steps, during the time period between the initial passage of the data-example during forward-propagation, and the eventual arrival of the deltas for that data-example during reverse propagation. Once the column of delta values is retrieved and used for weight-update in the fourth step, then it can be discarded, and that column re-used for storing forward-excitation data for the next incoming data-example. Thus two pointers—one for incoming example m now being forward-propagated, and one for incoming example n now being reverse-propagated—are maintained and updated at each layer of the network.

As outlined above, a second RPU array is used for each layer to hold onto the excitations locally, and provides for a throughput on fully-connected layers of one data-example for every five clock cycles. In this way, throughput is maximized while long-range transmission of data is eliminated. This technique is independent of the number of layers in the network, and may be applied to a variety of networks including LSTM, and CNN with ex-situ weight-update.

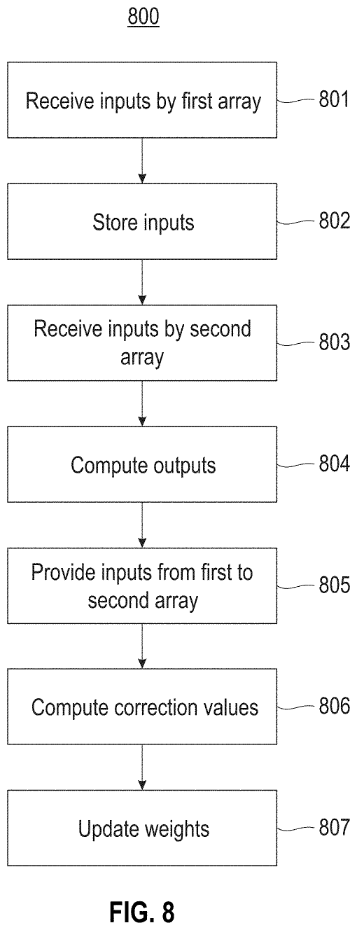

Referring to FIG. 8, a method of operating a neural network is illustrated according to embodiments of the present disclosure. At 801, an array of inputs is received by a first synaptic array in a hidden layer from a prior layer during a feed forward operation. At 802, the array of inputs is stored by the first synaptic array during the feed forward operation. At 803, the array of inputs is received by a second synaptic array in the hidden layer during the feed forward operation. At 804, the second synaptic array computes outputs from array of inputs based on weights of the second synaptic array during the feed forward operation. At 805, the stored array of inputs is provided from the first synaptic array to the second synaptic array during a back propagation operation. At 806, correction values are received by the second synaptic array during the back propagation operation. At 807, based on the correction values and the stored array of inputs, the weights of the second synaptic array are updated.

Accordingly, in various embodiments, training data are processed using on a series of tasks that implement forward propagation, back propagation, and weight updates.

In a first task, the parallel data vector containing the x vectors for layer q of image m is propagated across the array-cores to arrive at the RPU array-core responsible for layer q computation, while also be preserved in the East-side periphery of the array-core responsible for layer q storage. The multiply-accumulate operations take place, setting up the next x vector.

In a second task, the x vector data held in the East-side periphery of the storage array-core is written column-wise into the data column associated with image m. In some embodiments, this would be done using an NVM of high endurance or the 3T1C synaptic circuit element which offers near-infinite endurance and a storage lifetime of several milliseconds.

In a third task, the next x vector data at the South-side of the computation array-core is placed onto the routing network and sent to the q+1 layer. This process can either inherently include the squashing function operation, or the squashing function can be applied at a point along the routing path before the ultimate destination.

In the first task of a subsequent iteration through the training data, corresponding to the point in time that the delta vector for layer q of image m is ready to be transmitted, the previously stored copy of the x vector for this same image m is retrieved, so that it is available at the west-side periphery of the layer q storage array-core.

In the second task of the subsequent iteration, the parallel delta vector for layer q of image m is propagated through the routing network to arrive at the south side of the same RPU array-core, leading to transpose multiply-accumulate operations (columns driven, integration along rows), resulting in stored charge representing the next delta vector in the West-side capacitors of the layer q computation array-core. A copy of the arriving delta vector is preserved in the south-side peripheral circuitry.

In the third task of the subsequent iteration, the previously retrieved x vector is transmitted from the storage array-core to the computation array-core, so that it is now available to the west-side periphery of the layer q computation array-core.

In the fourth task of the subsequent iteration, the x vector information at the west-side periphery and the delta vector information at the south-side periphery are combined to perform the usual crossbar-compatible weight update typical for RPU-array neural network weight-update.

In the fifth task of the subsequent iteration, any derivative information available at the west-side periphery is applied to the next delta vector that was produced in the second task.

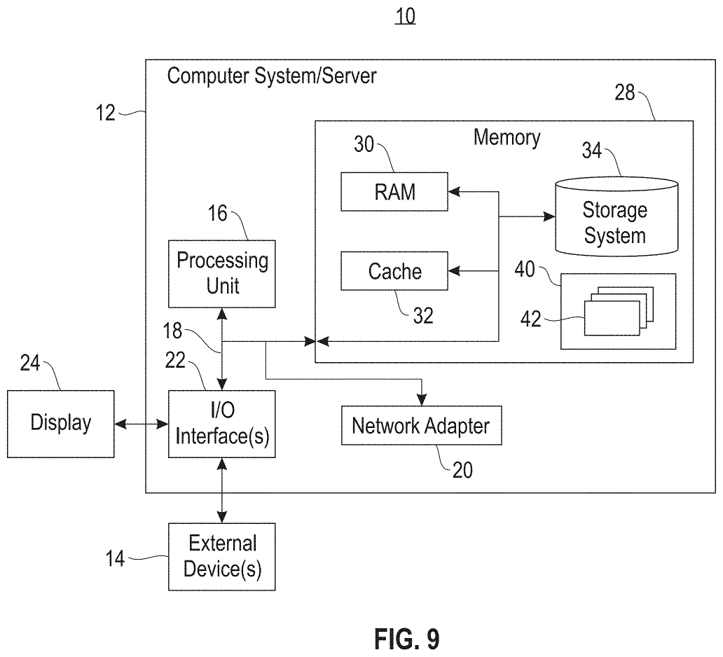

Referring now to FIG. 9, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An artificial neural network, comprising a plurality of synaptic arrays, wherein:
each of the plurality of synaptic arrays comprises a plurality of ordered input wires, a plurality of ordered output wires, and a plurality of synapses;
each of the synapses is operatively coupled to one of the plurality of input wires and to one of the plurality of output wires;
each of the plurality of synapses comprises a resistive element configured to store a weight;
the plurality of synaptic arrays are configured in a plurality of layers, comprising at least one input layer, one hidden layer, and one output layer;
a first of the at least one of the synaptic arrays in the at least one hidden layer is configured to receive and store an array of inputs from a prior layer during a feed forward operation;
a second of the at least one of the synaptic arrays in the at least one hidden layer is configured to receive the array of inputs from the prior layer, and compute outputs from the at least one hidden layer based on the weights of the second synaptic array during the feed forward operation;
the first of the at least one of the synaptic arrays is configured to provide the stored array of inputs to the second of the at least one of the synaptic arrays during a back propagation operation; and
the second of the at least one of the synaptic arrays is configured to receive correction values during the back propagation operation, and based on the correction values and the stored array of inputs, update its weights.

2. The artificial neural network of claim 1, wherein the feed forward operation is pipelined.

3. The artificial neural network of claim 1, wherein the back propagation operation is pipelined.

4. The artificial neural network of claim 1, wherein the feed forward operation and the back propagation operation are performed concurrently.

5. The artificial neural network of claim 1, wherein the first of the at least one of the synaptic arrays is configured to store one array of inputs per column.

6. The artificial neural network of claim 1, wherein each of the plurality of synapses comprises a memory element.

7. The artificial neural network of claim 1, wherein each of the plurality of synapses comprises an NVM or 3T1C.

8. A device, comprising:
a first and a second synaptic array, each of the first and second synaptic arrays comprising a plurality of ordered input wires, a plurality of ordered output wires, and a plurality of synapses, wherein
each of the plurality of synapses is operatively coupled to one of the plurality of input wires and to one of the plurality of output wires;
each of the plurality of synapses comprises a resistive element configured to store a weight;
the first synaptic array is configured to receive and store an array of inputs from a prior layer of artificial neural network during feed forward operation;
the second synaptic array is configured to receive the array of inputs from the prior layer, and compute outputs based on the weights of the second synaptic array during the feed forward operation;
the first synaptic array is configured to provide the stored array of inputs to the second synaptic array during a back propagation operation; and
the second synaptic array is configured to receive correction values during the back propagation operation, and based on the correction values and the stored array of inputs, update its weights.

9. The device of claim 8, wherein the feed forward operation is pipelined.

10. The device of claim 8, wherein the back propagation operation is pipelined.

11. The device of claim 8, wherein the feed forward operation and the back propagation operation are performed concurrently.

12. The device of claim 8, wherein the first synaptic array is configured to store one array of inputs per column.

13. The device of claim 8, wherein each of the plurality of synapses comprises a memory element.

14. The artificial neural network of claim 1, wherein each of the plurality of synapses comprises an NVM or 3T1C.

15. A method comprising:
receiving an array of inputs by a first synaptic array in a hidden layer from a prior layer during a feed forward operation;
storing the array of inputs by the first synaptic array during the feed forward operation;
receiving the array of inputs by a second synaptic array in the hidden layer during the feed forward operation;
computing by the second synaptic array outputs from array of inputs based on weights of the second synaptic array during the feed forward operation;
providing the stored array of inputs from the first synaptic array to the second synaptic array during a back propagation operation;
receiving correction values by the second synaptic array during the back propagation operation; and
based on the correction values and the stored array of inputs, updating the weights of the second synaptic array.

16. The method of claim 15, wherein the feed forward operation is pipelined.

17. The method of claim 15, wherein the back propagation operation is pipelined.

18. The method of claim 15, wherein the feed forward operation and the back propagation operation are performed concurrently.

19. The method of claim 15, wherein the first synaptic array is configured to store one array of inputs per column.

20. The method of claim 15, wherein each of the plurality of synapses comprises a memory element.
